(19) United States
(12) Patent Application Publication
(10) Pub. No.: US 2018/0360069 A1
(43) Pub. Date: Dec. 20, 2018

(54) TETRAHYDROCANNABINOL CHEWING GUM

(71) Applicant: Yury Leon Shmerlis, Tampa, FL (US)

(72) Inventor: Yury Leon Shmerlis, Tampa, FL (US)

(21) Appl. No.: 15/622,587

(22) Filed: Jun. 14, 2017

(51) Int. Cl. A23G 4/06

(52) U.S. Cl. CPC A23G 4/068; A23V 2002/00; A23G 4/06

(57) ABSTRACT

A tetrahydrocannabinol chewing gum for delivering tetrahydrocannabinol (THC) to a user comprises one or more ingredients. The chewing gum core comprises one or more of tetrahydrocannabinol (THC), gingerol, and caffeine. The user ingesting the tetrahydrocannabinol chewing gum receives tetrahydrocannabinol (THC) from the tetrahydrocannabinol chewing gum.

### TECHNICAL FIELD OF THE INVENTION

The invention disclosed herein generally relates to chewing gum. More particularly, the invention relates to a tetrahydrocannabinol chewing gum comprising tetrahydrocannabinol (THC) for delivering THC to a user.

### BACKGROUND

Tetrahydrocannabinol (THC) refers to the main psychoactive component of cannabis. A psychoactive component is a chemical substance that alters brain function and induces changes in perception or mood of a user. Although cannabis are primarily used as a recreational drug, the component THC does have several medical applications. Traditionally, THC and its isomers have been known to treat anorexia in people with Acquired Immune Deficiency Syndrome (AIDS). Additionally, THC has been used to treat refractory nausea and vomiting in patients undergoing chemotherapy. In patients suffering from neuropathic pain, spasticity, overactive bladder, etc., THC has been used to alleviate pain. Existing methods of absorbing THC require a user to smoke, vaporize, or ingest cannabis plant matter. Using this method affects the lungs of the user especially if the user has a related breathing condition. Moreover, smoking may result in the user contracting severe cough. For patients already suffering from pain due to their medical condition, this is highly disadvantageous.

Hence, there is a long felt but unresolved need for a method of ingesting tetrahydrocannabinol (THC), which eliminates the need to smoke, vaporize, or ingest cannabis plant matter.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The tetrahydrocannabinol chewing gum disclosed herein addresses the above-mentioned need for a method of ingesting tetrahydrocannabinol (THC), which eliminates the need to smoke, vaporize, or ingest cannabis plant matter. The tetrahydrocannabinol chewing gum for delivering tetrahydrocannabinol (THC) to a user, disclosed herein, comprises one or more ingredients. The chewing gum comprises tetrahydrocannabinol (THC), gingerol, and caffeine. The user ingesting the tetrahydrocannabinol chewing gum receives tetrahydrocannabinol (THC) from the tetrahydrocannabinol chewing gum.

### DETAILED DESCRIPTION OF THE INVENTION

The present invention relates to a tetrahydrocannabinol chewing gum for delivering tetrahydrocannabinol (THC) to a user. The tetrahydrocannabinol chewing gum comprises one or more ingredients. The tetrahydrocannabinol chewing gum comprises tetrahydrocannabinol (THC), gingerol, and caffeine. The user ingesting the tetrahydrocannabinol chewing gum receives tetrahydrocannabinol (THC) from the tetrahydrocannabinol chewing gum. In an embodiment, the tetrahydrocannabinol chewing gum comprises one or more flavors based on a preference of the user. In another embodiment, the tetrahydrocannabinol chewing gum comprises artificial sweeteners based on a preference of the user. Moreover, the chewing gum may also comprise vitamins, antibiotics, colorants, etc. The tetrahydrocannabinol chewing gum ensures delivery of tetrahydrocannabinol (THC) to the user who ingests it. The addition of vitamins or antibiotics provides added benefits to users having one or more medical conditions. When a user chews the tetrahydrocannabinol chewing gum with tetrahydrocannabinol (THC), the absorption happens through the lining of the mouth without the harmful effects of smoking cannabis. Furthermore, this eliminates the need to smoke, vaporize, or ingest cannabis plant matter.

The foregoing examples have been provided merely for the purpose of explanation and are in no way to be construed as limiting of the tetrahydrocannabinol chewing gum, disclosed herein. While the tetrahydrocannabinol chewing gum has been described with reference to various embodiments, it is understood that the words, which have been used herein, are words of description and illustration, rather than words of limitation. Further, although the tetrahydrocannabinol chewing gum, has been described herein with reference to particular means, materials, and embodiments, the tetrahydrocannabinol chewing gum is not intended to be limited to the particulars disclosed herein; rather, the tetrahydrocannabinol chewing gum extends to all functionally equivalent structures, methods and uses, such as are within the scope of the appended claims. Those skilled in the art, having the benefit of the teachings of this specification, may effect numerous modifications thereto and changes may be made without departing from the scope and spirit of the tetrahydrocannabinol chewing gum disclosed herein in their aspects.

What is claimed is:

1. A tetrahydrocannabinol chewing gum for delivering tetrahydrocannabinol (THC) to a user, the tetrahydrocannabinol chewing gum comprising:
tetrahydrocannabinol (THC);
gingerol; and
caffeine
wherein ingesting the tetrahydrocannabinol chewing gum delivers the tetrahydrocannabinol (THC) to the user.

2. The tetrahydrocannabinol chewing gum of claim 1, further comprising:
one or more flavors.

3. The tetrahydrocannabinol chewing gum of claim 1, further comprising:
one or more artificial sweeteners.
